(19) United States
(12) Patent Application Publication
(10) Pub. No.: US 2024/0345459 A1
(43) Pub. Date: Oct. 17, 2024

(54) LENS BARREL UNIT

(71) Applicant: CANON KABUSHIKI KAISHA, Tokyo (JP)

(72) Inventor: TOMOYA ONAKA, Kanagawa (JP)

(21) Appl. No.: 18/630,813

(22) Filed: Apr. 9, 2024

(30) Foreign Application Priority Data
Apr. 14, 2023 (JP) 2023-066475

(51) Int. Cl. G03B 17/14

(52) U.S. Cl. CPC G03B 17/14

(57) ABSTRACT

A lens barrel unit includes a lens unit including at least one lens, an optical-filter holding member, and a drive member. The optical-filter holding member holds an optical filter and is insertable into and removable from a light path of the at least one lens. The drive member inserts or removes the optical-filter holding member into or from the light path. The drive member further engages with the optical-filter holding member and has an opening penetrating in a direction of an optical axis of the at least one lens. At least part of the lens unit is arranged in the opening of the drive member.

### BACKGROUND

### Field

The present disclosure relates to a lens barrel unit that includes a filter switching mechanism.

### Description of the Related Art

There have been conventionally known lens barrel units that are equipped with a filter switching mechanism that causes an infrared cut filter or a neutral density (ND) filter to be inserted into or removed from a light path. For example, Japanese Patent Application Laid-Open No. 2020-194031 discusses a filter switching mechanism that causes a filter frame holding a filter to be inserted into or removed from a light path by an actuator using a worm gear.

### SUMMARY

The present disclosure is directed to providing a lens barrel unit that includes a filter switching mechanism and can be reduced in size in the direction of an optical axis.

According to an aspect of the present disclosure, a lens barrel unit includes a lens unit including at least one lens, an optical-filter holding member configured to hold an optical filter and insertable into and removable from a light path of the at least one lens, and a drive member configured to insert or remove the optical-filter holding member into or from the light path, wherein the drive member further is configured to engage with the optical-filter holding member and has an opening penetrating in a direction of an optical axis of the at least one lens, and wherein at least part of the lens unit is arranged in the opening of the drive member.

Further features of the present disclosure will become apparent from the following description of exemplary embodiments with reference to the attached drawings.

### BRIEF DESCRIPTION OF THE DRAWINGS

FIG. 1 is a perspective view of an imaging apparatus according to a first exemplary embodiment of the present disclosure.

FIGS. 2A and 2B are a perspective view and a cross-sectional view of a camera unit according to the first exemplary embodiment, respectively, and each illustrate a state where an infrared cut filter is inserted into a light path.

FIG. 3 is an exploded perspective view of a lens barrel unit according to the first exemplary embodiment.

FIG. 4 is a cross-sectional view of the camera unit according to the first exemplary embodiment, and illustrates a state where dummy glass is inserted into the light path.

FIGS. 5A to 5C are diagrams illustrating arrangement of a filter holding frame, a worm, and a worm wheel at the time of filter switching driving according to the first exemplary embodiment.

FIG. 6 is a perspective view illustrating arrangement of the filter holding frame, the worm, and the worm wheel according to the first exemplary embodiment.

FIG. 7 is a cross-sectional view of the lens barrel unit according to the first exemplary embodiment.

FIGS. 8A and 8B are a front view and a side view illustrating arrangement of the filter holding frame, the worm, the worm wheel, and a lens unit of the first exemplary embodiment, respectively.

FIGS. 9A to 9C are diagrams illustrating arrangement of a filter holding frame, a worm, and a worm wheel at the time of filter switching driving according to a second exemplary embodiment.

### DESCRIPTION OF THE EMBODIMENTS

Hereinafter, exemplary embodiments for carrying out the present disclosure will be described in detail with reference to the attached drawings.

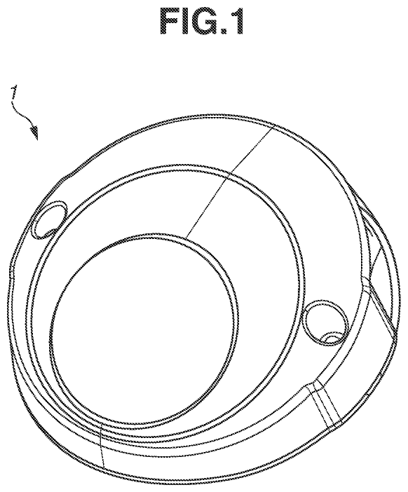

Hereinafter, some exemplary embodiments of the present disclosure will be described in detail with reference to the attached drawings. FIG. 1 is a perspective view of an imaging apparatus 1 according to a first exemplary embodiment of the present disclosure. The imaging apparatus 1 includes a camera unit (optical device) 2.

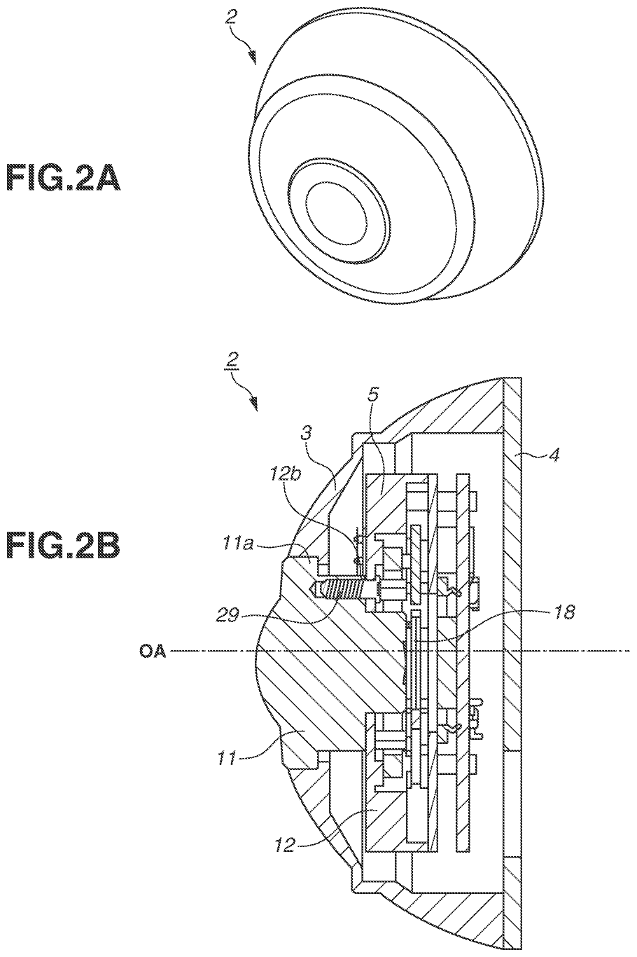

FIG. 2A is a perspective view of the camera unit 2, and FIG. 2B is a cross-sectional view of the camera unit 2 illustrated in FIG. 2A along an optical axis OA. The left side (subject side or object side) of FIG. 2A will be referred to as a front side, and the right side of FIG. 2A will be referred to as a back side. The camera unit 2 includes a front-side holder 3 and a back-side holder 4, and has a substantially hemispherical shape. The camera unit 2 has a lens barrel unit (lens apparatus) 5 therein. The lens barrel unit 5 is interposed and fixed between the front-side holder 3 and the back-side holder 4.

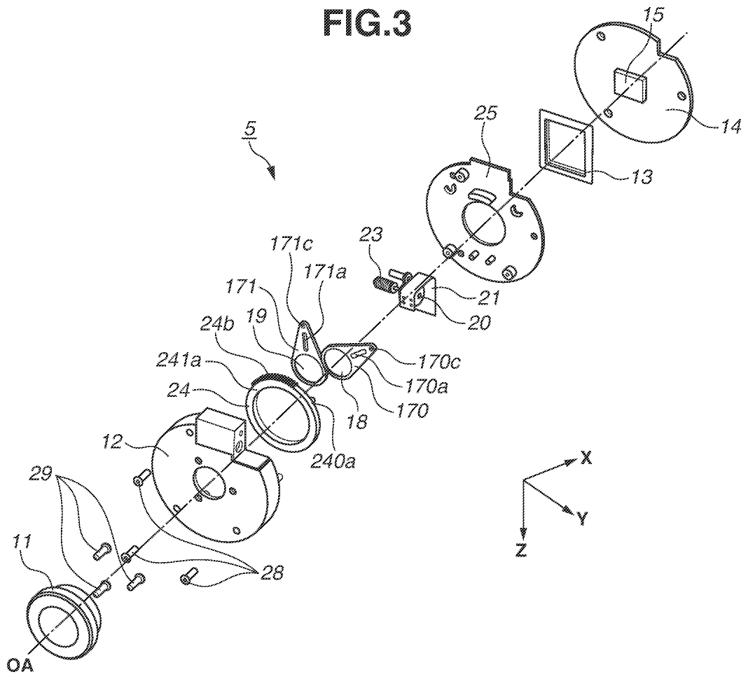

FIG. 3 is an exploded perspective view of the lens barrel unit 5. The lens barrel unit 5 includes a lens unit 11, a fixing barrel 12, a dust-proof rubber 13, an imaging element substrate 14, filter holding frames 170 and 171, an actuator 20, and a cover member 25.

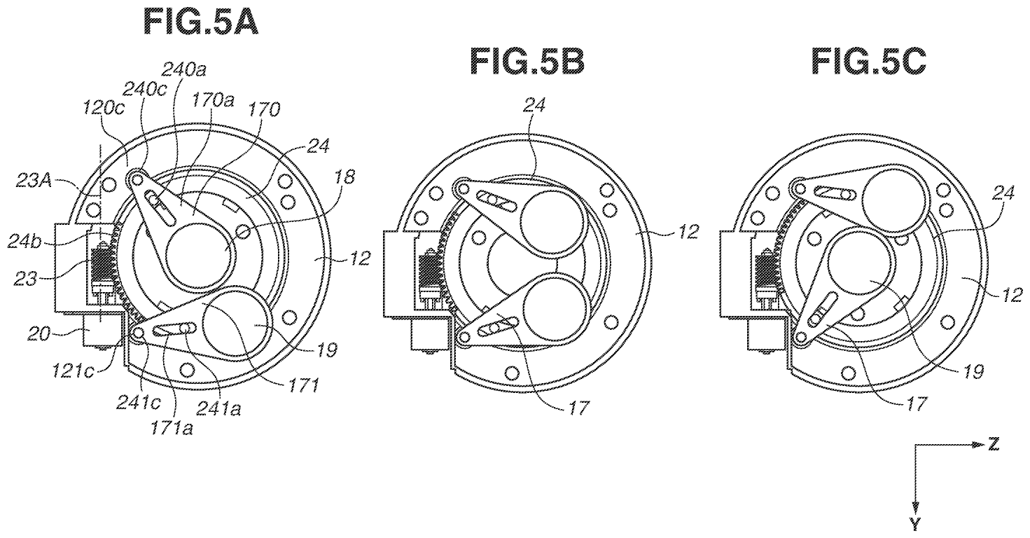

The lens unit 11 includes one or more lenses. The one or more lenses may be movable in the direction of the optical axis (X-axis direction) or may be immovable (fixed). The lenses may include a focus lens for focus adjustment and a zoom lens (magnification lens) that changes a focal length. As illustrated in FIG. 2B, the lens unit 11 has screw holes 11a formed therein. The fixing barrel 12 has attachment holes 12b. The screw holes 11a and the attachment holes 12b are fixed by screws 29, whereby the lens unit 11 is fixed to the fixing barrel 12. The fixing barrel 12 holds the lens unit 11. The fixing barrel 12 also holds the actuator 20 and supports an intermediate gear unit 24 described below so as to be rotatable between the fixing barrel 12 and the cover member 25. The fixing barrel 12 also includes guide shafts 120c and 121c (illustrated in FIG. 5A) that protrude toward the filter holding frames 170 and 171.

The dust-proof rubber 13 engages with the cover member 25 to prevent dust from entering the lens barrel unit 5. The dust-proof rubber 13 also suppresses vibration. The dust-proof rubber 13 is interposed between the cover member 25 and the imaging element substrate 14. The imaging element substrate 14 is a substrate on which an imaging element 15 is mounted and is fixed to the cover member 25. The imaging element 15 subjects an optical image formed via an imaging optical system to photoelectric conversion, and includes a photoelectric conversion element such as a charge-coupled device (CCD) sensor or a complementary metal oxide semiconductor (CMOS) sensor.

The filter holding frame 170 (optical filter holding member) holds an infrared cut filter (optical filter) 18 for shutting out infrared rays. The filter holding frame 171 (filter holding member) holds dummy glass 19. The filter holding frame 171 may hold a filter such as a neutral density (ND) filter, instead of the dummy glass 19. The filter holding frames 170 and 171 have engagement holes 170a and 171a (engaged portions) that penetrate through the filter holding frames 170 and 171 in the X-axis direction (the direction of the optical axis), respectively. The filter holding frames 170 and 171 further have guide holes 170c and 171c with which the guide shafts 120c and 121c of the fixing barrel 12 engage, respectively. The filter holding frames 170 and 171 can be rotated about the guide shafts 120c and 121c, respectively. The filter holding frames 170 and 171 are restricted from moving in the X-axis direction by the fixing barrel 12 and the cover member 25.

The filter holding frames 170 and 171 are driven by a drive unit (drive member) and are insertable into and removable from the light path of the lens. Specifically, the drive unit drives the filter holding frames 170 and 171 such that the infrared cut filter 18 or the dummy glass 19 moves between a position on the optical axis OA of the lens and a position retracted from the optical axis OA. In FIG. 2A, the infrared cut filter 18 is disposed on the optical axis OA. The filter holding frames 170 and 171 move on a plane orthogonal to the optical axis OA of the lens. The configuration of the drive unit will be described below.

The actuator 20, such as a motor, that serves as a drive source rotates the filter holding frames 170 and 171 around the guide shafts 120c and 121c. The actuator 20 is connected to a flexible printed board 21.

The cover member 25 is fastened to the fixing barrel 12 by screws 28 (FIG. 3). The cover member 25 is arranged between the imaging element substrate 14 and the drive unit.

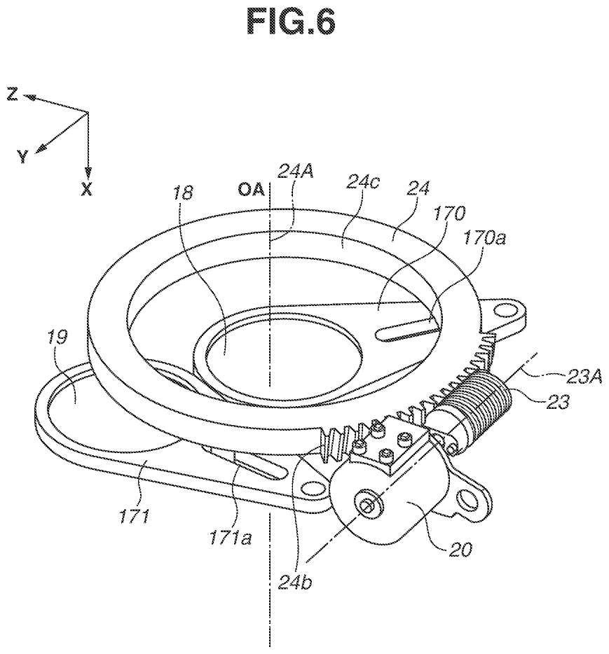

Next, the drive unit will be described in detail. FIG. 6 is a perspective view illustrating arrangement of the filter holding frames 170 and 171, a worm 23, and the intermediate gear unit 24.

The drive unit (drive member) includes the actuator 20, the worm (cylindrical worm) 23 fixed to the actuator 20, and the intermediate gear unit (rotation member) 24. The intermediate gear unit 24 has a worm wheel (helical gear) 24b and engagement pins 240a and 241a (engagement portions) (FIG. 5A).

The worm 23 is coupled to the actuator 20 and is rotated integrally with the actuator 20. The worm 23 is a gear that is threaded like a screw and has a small number of teeth. The direction of a rotation axis 23A of the worm 23 is identical (parallel) to the Y-axis direction that is the drive direction of the filter holding frames 170 and 171. Accordingly, the long-side direction of the actuator 20 and the drive direction of the filter holding frames 170 and 171 are the same direction, which can make it possible to reduce the size of the imaging apparatus 1.

The intermediate gear unit 24 is restricted from moving in the direction of the optical axis OA by the fixing barrel 12 and the cover member 25. The intermediate gear unit 24 is restricted from moving in the direction perpendicular to the optical axis OA by a projection (not illustrated) protruding from the fixed lens barrel. The fixing barrel 12 and the cover member 25 are fastened and fixed together by the screws 28. The intermediate gear unit 24 has a circular shape (cylindrical shape) with an opening 24c therein, and the worm wheel 24b that engages with the worm 23 is formed in a part of the outer peripheral portion of the intermediate gear unit 24. The opening 24c penetrates through the intermediate gear unit 24 in the direction of the optical axis OA of the lens.

A rotation axis 24A (FIG. 6) of the worm wheel 24b is substantially coaxial with the optical axis OA. Specifically, as illustrated in FIG. 6, the worm wheel 24b has the rotation axis 24A that is substantially identical to the optical axis OA. The worm wheel 24b engages with the worm 23 and constitutes a worm gear together with the worm 23.

The engagement pins 240a and 241a are integrated with the worm wheel 24b and thus rotate along with the rotation of the worm wheel 24b. The engagement pins 240a and 241a engage with the engagement holes 170a and 171a formed in the filter holding frames 170 and 171, respectively.

The worm wheel 24b is located at the position more distant from the optical axis OA than the engagement pins 240a and 241a. In other words, the engagement pins 240a and 241a are located further inward in a radial direction of the intermediate gear unit 24 than the worm wheel 24b. With this arrangement, the filter holding frames 170 and 171 and the drive unit can set within a certain area as viewed from the direction of the optical axis OA. Accordingly, the camera unit 2 and the imaging apparatus 1 can be reduced in size.

With the configuration described above, the driving force of the actuator 20 is transmitted to the filter holding frames 170 and 171 via the worm 23 and the intermediate gear unit 24. The worm gear can regulate the transmission of the rotation from the worm wheel 24b side to the worm 23 side by adjusting the lead angle of the groove in the worm 23 (self-lock function). That is, a load P necessary to rotate the worm 23 can be increased by adjusting the lead angle of the groove in the worm 23. For example, the load P necessary to rotate the worm 23 is made greater than the load applied to the filter holding frames 170 and 171 in the direction of insertion and removal of the filter holding frames 170 and 171 when the camera unit 2 undergoes impact or vibration.

This suppresses the accidental insertion and removal of the filter holding frames 170 and 171. Since the drive unit also acts as a lock mechanism as described above, there is no need to separately provide a lock mechanism. This makes it possible to reduce the sizes of the imaging apparatus 1 and the camera unit 2. In addition, the worm wheel 24b may be made large in size to increase the reduction ratio of the worm gear. In this case, the motor can be driven with further smaller electric power and the load P that can be regulated by the self-lock function can be further increased.

Next, a filter switching operation according to the present exemplary embodiment will be described with reference to FIGS. 5A, 5B and 5C. FIGS. 5A to 5C are diagrams illustrating arrangement of the filter holding frames, the worm, and the worm wheel at the time of filter switching driving according to the present exemplary embodiment. When a drive signal is input to the actuator 20 via electrical wiring (not illustrated) connected to the imaging element substrate 14, a rotor of the actuator 20 rotates around the rotation axis 23A. When the rotor of the actuator 20 rotates, the worm 23 fixed in the rotation axis 23A and the worm wheel 24b (the intermediate gear unit 24) engaging with the worm 23 also rotate. When the intermediate gear unit 24 rotates, the filter holding frames 170 and 171 are rotated around the guide shafts 120c and 121c in the +Y direction or the −Y direction via the engagement pins 240a and 241a and the engagement holes 170a and 171a, respectively. In addition, a drive signal is input to the actuator 20 so as to stop the filter holding frames 170 and 171 after they move by a predetermined amount.

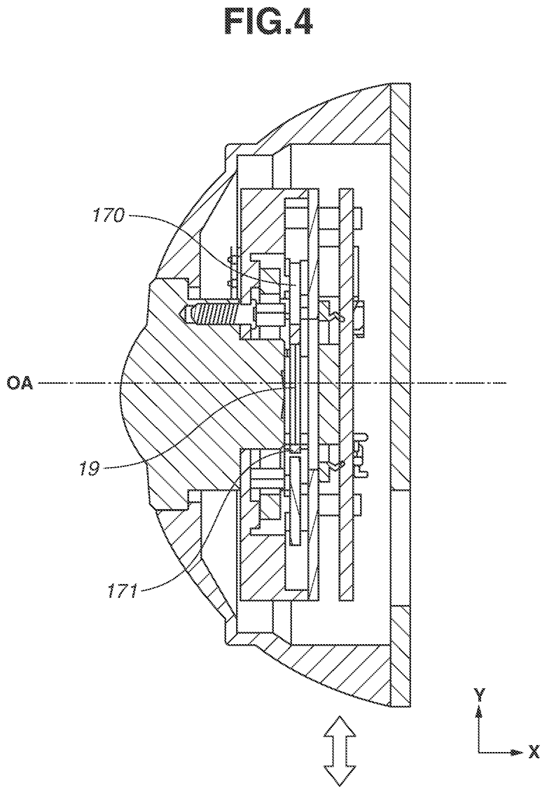

FIGS. 2B and 5A illustrate a state where the infrared cut filter 18 is inserted into the light path (the optical axis OA), and FIGS. 4 and 5C illustrate a state where the dummy glass 19 is inserted into the light path. When the filter holding frames 170 and 171 are driven in the directions orthogonal to the optical axis shown by a bidirectional arrow in FIG. 4, the infrared cut filter 18 and the dummy glass 19 are selectively inserted into the light path. FIG. 5B illustrates an intermediate state of transition from the state in FIG. 5A to the state in FIG. 5C in which the filter holding frames 170 and 171 are inserted into the light path.

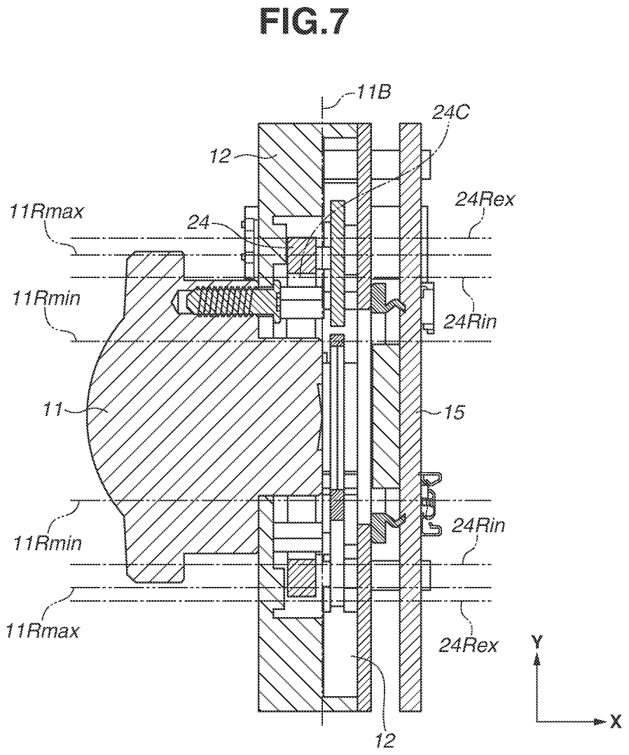

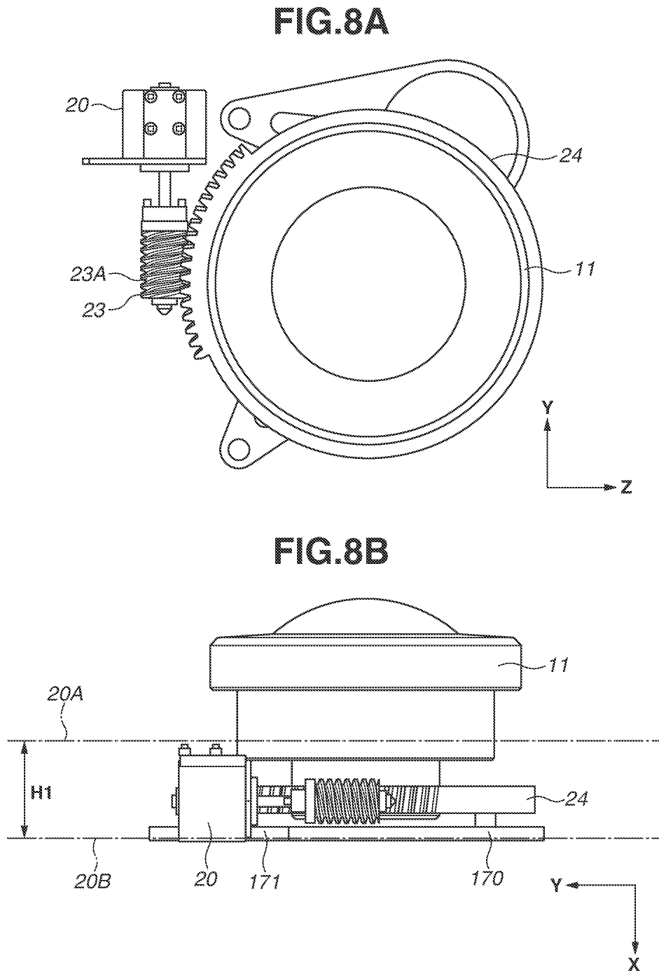

Subsequently, further details of the lens barrel unit 5 will be described with reference to FIGS. 7 and 8.

FIG. 7 is a cross-sectional view of the lens barrel unit 5 along the optical axis OA. An internal diameter 24Rin of the cylinder of the intermediate gear unit 24 in the present exemplary embodiment is larger than a minimum external diameter 11Rmin of the lens unit 11 (11Rmin<24Rin).

Accordingly, the intermediate gear unit 24 can be arranged without intersecting the light beam from the lens included in the lens unit 11. A portion of the lens unit 11 is inserted into the cylinder of the intermediate gear unit 24. In other words, a portion of the lens unit 11 is arranged in the opening (in the opening 24c) of the intermediate gear unit 24 (the rotation member). In this manner, since a portion of the lens unit 11 can be inserted into the cylinder of the intermediate gear unit 24, the entire length of the lens barrel unit 5 from the object side of the lens unit 11 to the imaging element substrate 14 determined by the length in the X-axis direction can be shortened. As a result, even if the front-side holder 3 and the back-side holder 4 form the substantially hemispherical shape as illustrated in FIG. 2B, the intermediate gear unit 24, the actuator 20, and the worm 23 can be stored inside the space formed by the front-side holder 3 and the back-side holder 4. This enables the lens barrel unit 5 to be thinner or smaller.

FIG. 8A is a front view of the camera unit 2 as viewed from the object side in the direction of the optical axis OA with the fixing barrel 12 and the cover member 25 omitted. FIG. 8B is a diagram illustrating the camera unit 2 as viewed from the −Z direction perpendicular to the optical axis OA with the fixing barrel 12 and the cover member 25 omitted. In the lens barrel unit 5 according to the present exemplary embodiment, as illustrated in FIG. 8A, the lens unit 11 and the intermediate gear unit 24 overlap when viewed from the front side (the object side in the direction of the optical axis OA). The lens unit 11 and the intermediate gear unit 24 are preferably arranged such that the maximum external diameter 11Rmax of the lens unit 11 falls between the internal diameter 24Rin and external diameter 24Rex of the intermediate gear unit 24 (24Rin<11Rmax<24Rex). In other words, when the inner diameter of the intermediate gear unit 24 is defined as R1, the external diameter of the intermediate gear unit 24 is defined as R2, and the maximum external diameter R3 of the lens unit 11 is defined as R3, R1<R3<R2 is satisfied.

Arranging the components in this manner enables the lens barrel unit 5 to be thinner or smaller without increasing the outer diameter. In addition, as illustrated in FIG. 8B, when viewed from the direction perpendicular to the optical axis OA, the filter holding frames 170 and 171 and the intermediate gear unit 24 are preferably arranged so as to overlap in the range between an object side end 20A to an imaging side end 20B of the actuator 20. Specifically, when the range of the actuator 20 with respect to the direction of the optical axis OA is defined as H1, the filter holding frames 170 and 171 and the intermediate gear unit 24 are partially within the range H1. As a result, the lens barrel unit 5 according to the present exemplary embodiment can be made thinner or smaller.

Next, a lens barrel unit according to a second exemplary embodiment of the present disclosure, which is different from the first exemplary embodiment, will be described. The second exemplary embodiment is similar in basic configuration to the first exemplary embodiment. However, the second exemplary embodiment is different from the first exemplary embodiment in the shapes of the engagement holes 170a and 171a of the filter holding frames 170 and 171.

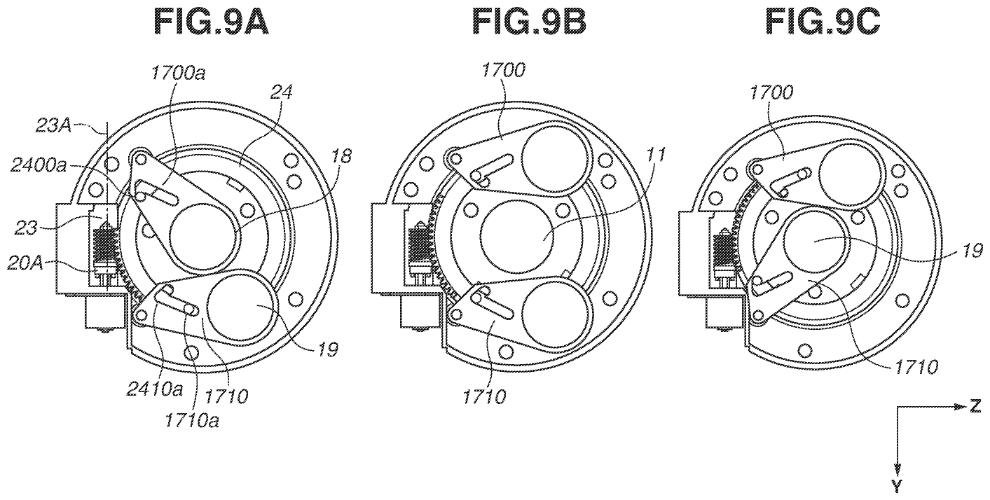

The shapes of engagement holes 1700a and 1710a according to the present exemplary embodiment are each an arc shape (curved shape) like a V shape. The engagement holes 1700a and 1710a engage with engagement pins 2400a and 2410a. This shape allows both filter holding frames 1700 and 1710 (FIGS. 9A to 9C) to be not inserted into the light path, unlike in the state of FIG. 5B.

A filter switching operation according to the present exemplary embodiment will be described with reference to FIGS. 9A, 9B and 9C. FIGS. 9A to 9C are diagrams illustrating arrangement of filter holding frames, a worm, and a worm wheel at the time of filter switching driving according to the present exemplary embodiment. When a drive signal is input to an actuator 20 via electrical wiring (not illustrated) connected to an imaging element substrate 14, a rotor of the actuator 20 rotates around a rotation axis 23A. When the rotor of the actuator 20 rotates, a worm 23 fixed in the rotation axis 23A and a worm wheel 24b (intermediate gear unit 24) engaging with the worm 23 rotate. When the intermediate gear unit 24 rotates, the filter holding frames 1700 and 1710 are rotated around guide shafts 120c and 121c in the +Y direction or the −Y direction via the engagement pins 2400a and 2410a and the engagement holes 1700a and 1710a, respectively. A drive signal is input to the actuator 20 such that the filter holding frames 1700 and 1710 stop after they move by a predetermined amount.

FIG. 9A illustrates a state where an infrared cut filter 18 is inserted into the light path (the optical axis OA), and FIG. 9C illustrates a state where dummy glass 19 is inserted into the light path. When the filter holding frames 1700 and 1710 are driven in the directions orthogonal to the optical axis OA shown by the bidirectional arrow in FIG. 4, the infrared cut filter 18 and the dummy glass 19 are selectively inserted into the light path. FIG. 9B illustrates an intermediate state of transition between the state in FIG. 9A and the state in FIG. 9C. In this state, the engagement pins 2400a and 2410a are arranged at positions on the bottoms of the V shaped engagement holes 1700a and 1710a, respectively, and the filter holding frames 1700 and 1710 are not inserted into the light path. As a result, the image converted by an imaging element 15 will be let directly pass through the lens barrel unit 5 under no influence of the filter holding frames 1700 and 1710 (unfiltered state).

As a result, the lens barrel unit 5 according to the second exemplary embodiment can be brought into three states, i.e., the state with insertion of the infrared cut filter 18, the state with insertion of the dummy glass 19, the unfiltered state. In other words, the three states are the state where the infrared cut filter 18 is inserted into the light path, the state where the dummy glass 19 is inserted into the light path, and the state where none of the infrared cut filter 18 and the dummy glass 19 is inserted into the light path.

### Other Exemplary Embodiments

Since the worm wheel 24b has a cylindrical shape, the worm may be provided on the outer periphery of the lens unit, for example. In addition, although the optical axis OA and the rotation axis 24A of the intermediate gear unit 24 are substantially identical in the foregoing examples, it suffices that the optical axis OA is included in the cylinder of the intermediate gear unit.

As the infrared cut filter 18 and the dummy glass 19, optical members such as ND filters and bandpass filters may be used. The optical elements are not limited in particular, and optical filters, various types of glass, or lenses that transmit light of a specific wavelength can be used.

In the worm gear, the worm and the helical gear (worm wheel) may be in point contact or line contact with each other. The worm may be a cylindrical worm or a double enveloping worm. The movement directions of the optical elements are not limited and may include the components of the direction of the optical axis and other direction.

FIG. 6 illustrates the engagement pins 240a and 241a and the engagement holes 170a and 171a that are arranged in the −Z direction, but they may be arranged in the +Z direction. The intermediate gear unit 24 may have engagement holes, and the filter holding frames 170 and 171 may include engagement pins.

In the above-described exemplary embodiments, the lens unit 11 and the fixing barrel 12 are separated. Alternatively, they may be integrated.

Some exemplary embodiments of the present disclosure have been described above. However, the present disclosure is not limited to these exemplary embodiments and can be modified and changed within the scope of the gist of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-066475, filed Apr. 14, 2023, which is hereby incorporated by reference herein in its entirety.

What is claimed is:

1. A lens barrel unit comprising:
a lens unit including at least one lens;
an optical-filter holding member configured to hold an optical filter and insertable into and removable from a light path of the at least one lens; and
a drive member configured to insert or remove the optical-filter holding member into or from the light path,
wherein the drive member further is configured to engage with the optical-filter holding member and has an opening penetrating in a direction of an optical axis of the at least one lens, and
wherein at least part of the lens unit is arranged in the opening of the drive member.

2. The lens barrel unit according to claim 1,
wherein the drive member includes a worm coupled to a drive source and a rotation member that has a circular shape with an opening and includes a worm wheel configured to engage with the worm, and
wherein the at least part of the lens unit is arranged within the opening of the rotation member.

3. The lens barrel unit according to claim 2, wherein the worm wheel is provided in a part of an outer peripheral portion of the rotation member.

4. The lens barrel unit according to claim 2, wherein the rotation member includes an engagement portion, and the optical-filter holding member has an engaged portion configured to engage with the engagement portion.

5. The lens barrel unit according to claim 4, wherein the engagement portion is located further inward in a radial direction of the rotation member than the worm wheel.

6. The lens barrel unit according to claim 4, wherein the engagement portion is an engagement pin, and the engaged portion is an engagement hole configured to engage with the engagement pin.

7. The lens barrel unit according to claim 6, wherein the engagement hole has a curved shape.

8. The lens barrel unit according to claim 2, wherein R1<R3<R2 is satisfied where an inner diameter of the rotation member is defined as R1, an outer diameter of the rotation member is defined as R2, and a maximum outer diameter of the lens unit is defined as R3.

9. The lens barrel unit according to claim 2, wherein an inner diameter of the rotation member is larger than a minimum outer diameter of the lens unit.

10. The lens barrel unit according to claim 1,
wherein the optical-filter holding member includes a first optical-filter holding member configured to hold a first optical filter and a second optical-filter holding member configured to hold a second optical filter, and
wherein the first optical-filter holding member and the second optical-filter holding member are configured to be moved on a plane orthogonal to the optical axis of the at least one lens.

11. The lens barrel unit according to claim 10, wherein the drive member is configured to drive the first optical-filter holding member and the second optical-filter holding member (i) such that the first optical-filter holding member is inserted into the light path, (ii) such that the second optical-filter holding member is inserted into the light path, or (iii) such that none of the first optical-filter holding member and the second optical-filter holding member is inserted into the light path.
